(19) United States
(12) Patent Application Publication
(10) Pub. No.: US 2016/0364700 A1
(43) Pub. Date: Dec. 15, 2016

(54) TRANSFER SYSTEM AND METHOD

(71) Applicant: MonetaGo Inc., New York, NY (US)

(72) Inventors: JESSE R. CHENARD, New York, NY (US); Patrick E. Manasse, New York, NY (US); Paul R. Davis, III, Jersey City, NJ (US)

(21) Appl. No.: 15/180,513

(22) Filed: Jun. 13, 2016

Related U.S. Application Data
(60) Provisional application No. 62/174,779, filed on Jun. 12, 2015.

(51) Int. Cl. G06Q 20/06; G06Q 20/38

(52) U.S. Cl. CPC G06Q 20/065; G06Q 20/382

(57) ABSTRACT

A computer-implemented method, computer program product and computing system for converting a first asset owned by a first entity into an intermediate digital asset. The intermediate digital asset is transferred to a second entity, thus resulting in an intermediate digital asset transfer. The intermediate digital asset transfer from the first entity to the second entity is recorded within a digital asset tracking system. The intermediate digital asset is converted into a second asset owned by the second entity.

### RELATED APPLICATION

This application claims the benefit of U.S. Provisional Application No. 62/174,779, filed on 12 Jun. 2015, entitled “Digital Currency Exchange Platform System and Method”, the contents of which are incorporated herein by reference.

### TECHNICAL FIELD

This disclosure relates to transfer systems and, more particularly, to asset transfer systems.

### BACKGROUND

During the course of business, assets often need to be transferred between entities. For example, a first financial institution may need to transfer a quantity of money to a second financial institution. During the course of these transfers, the transferring entity may be located at a first location that uses a first currency, and the transfer may result in the money being transferred to a location that uses a different currency. Accordingly, the money being transferred may need to be converted from a first currency to a second currency.

During the course of such monetary transfers, documents are often executed to effectuate the transfer, wherein these documents may need to be executed by both the transferring party and the receiving party, wherein the fully-executed document may then be stored by one or both of the parties.

### SUMMARY OF DISCLOSURE

In one implementation a computer-implemented method is executed on a computing device and includes converting a first asset owned by a first entity into an intermediate digital asset. The intermediate digital asset is transferred to a second entity, thus resulting in an intermediate digital asset transfer. The intermediate digital asset transfer from the first entity to the second entity is recorded within a digital asset tracking system. The intermediate digital asset is converted into a second asset owned by the second entity.

One or more of the following features may be included. The first asset may be is a first currency and the second asset may be a second currency. The intermediate digital asset may include one or more of: a cryptocurrency, a digital treasury bill and a digital contract. The digital asset tracking system may include a transfer tracking database system. The digital asset tracking system may include a block chaining system. The digital asset tracking system may include a transfer tracking ledger system. The first entity may include one or more of: a first individual, a first business entity, and a first government entity. The second entity may include one or more of: a second individual, a second business entity, and a second government entity.

In another implementation, a computer program product resides on a computer readable medium and has a plurality of instructions stored on it. When executed by a processor, the instructions cause the processor to perform operations including converting a first asset owned by a first entity into an intermediate digital asset. The intermediate digital asset is transferred to a second entity, thus resulting in an intermediate digital asset transfer. The intermediate digital asset transfer from the first entity to the second entity is recorded within a digital asset tracking system. The intermediate digital asset is converted into a second asset owned by the second entity.

One or more of the following features may be included. The first asset may be is a first currency and the second asset may be a second currency. The intermediate digital asset may include one or more of: a cryptocurrency, a digital treasury bill and a digital contract. The digital asset tracking system may include a transfer tracking database system. The digital asset tracking system may include a block chaining system. The digital asset tracking system may include a transfer tracking ledger system. The first entity may include one or more of: a first individual, a first business entity, and a first government entity. The second entity may include one or more of: a second individual, a second business entity, and a second government entity.

In another implementation, a computing system includes a processor and a memory system configured to perform operations including converting a first asset owned by a first entity into an intermediate digital asset. The intermediate digital asset is transferred to a second entity, thus resulting in an intermediate digital asset transfer. The intermediate digital asset transfer from the first entity to the second entity is recorded within a digital asset tracking system. The intermediate digital asset is converted into a second asset owned by the second entity.

One or more of the following features may be included. The first asset may be is a first currency and the second asset may be a second currency. The intermediate digital asset may include one or more of: a cryptocurrency, a digital treasury bill and a digital contract. The digital asset tracking system may include a transfer tracking database system. The digital asset tracking system may include a block chaining system. The digital asset tracking system may include a transfer tracking ledger system. The first entity may include one or more of: a first individual, a first business entity, and a first government entity. The second entity may include one or more of: a second individual, a second business entity, and a second government entity.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a transfer process according to an embodiment of the present disclosure;

FIG. 2 is a flowchart of the transfer process of FIG. 1 according to an embodiment of the present disclosure; and

FIG. 3 is a diagrammatic view of a digital asset tracking system utilized by the transfer process of FIG. 1 according to an embodiment of the present disclosure.

Like reference symbols in the various drawings indicate like elements.

### DETAILED DESCRIPTION OF THE PREFERRED EMBODIMENTS

### System Overview

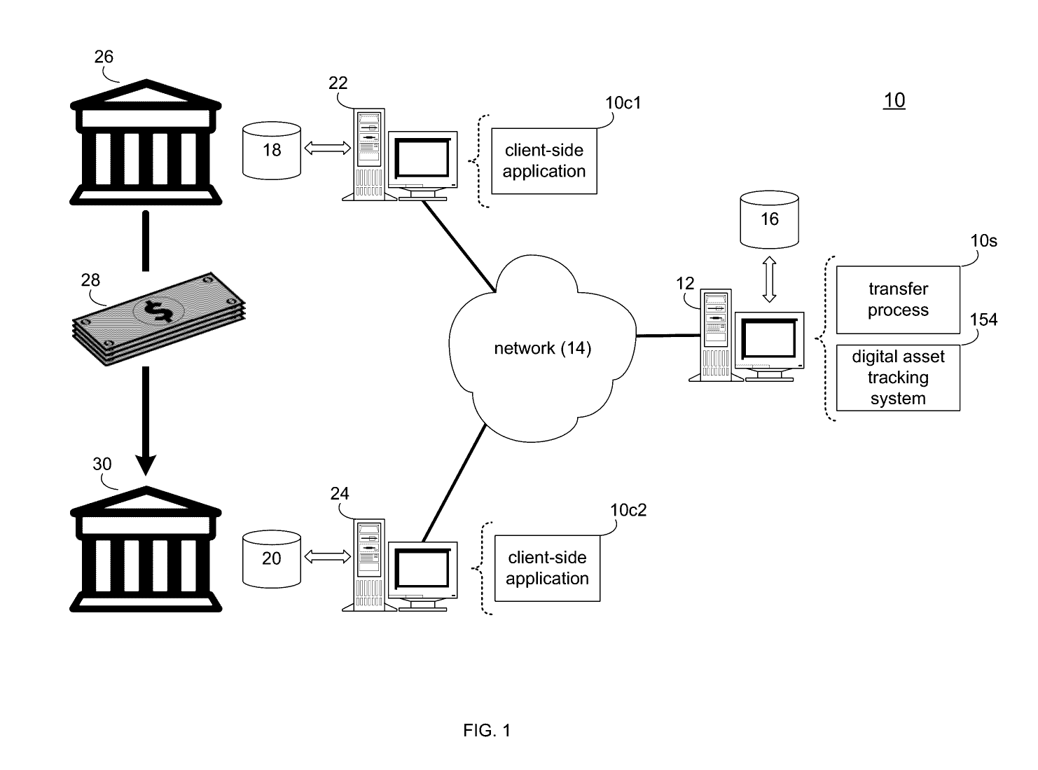

In FIG. 1, there is shown transfer process 10. Transfer process 10 may be implemented as a server-side process, a client-side process, or a hybrid server-side/client-side process. For example, transfer process 10 may be implemented as a purely server-side process via transfer process 10s. Alternatively, transfer process 10 may be implemented as a purely client-side process via one or more of client-side application 10c1 and client-side application 10c2. Alternatively still, transfer process 10 may be implemented as a hybrid server-side/client-side process via transfer process 10s in combination with one or more of client-side application 10c1 and client-side application 10c2. Accordingly, transfer process 10 as used in this disclosure may include any combination of transfer process 10s, client-side application 10c1 and client-side application 10c2.

Transfer process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing network.

The instruction sets and subroutines of transfer process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Examples of client-side applications 10c1, 10c2 may include but are not limited to a web browser or a specialized application (e.g., an application running on e.g., the Android™ platform or the iOS™ platform). The instruction sets and subroutines of client-side applications 10c1, 10c2 which may be stored on storage devices 18, 20 (respectively) coupled to client electronic devices 22, 24 (respectively), may be executed by one or more processors (not shown) and one or more memory architectures (not shown) incorporated into client electronic devices 22, 24 (respectively).

Examples of storage devices 18, 20 may include but are not limited to: hard disk drives; RAID devices; random access memories (RAM); read-only memories (ROM), and all forms of flash memory storage devices. Examples of client electronic devices 22, 24 may include, but are not limited to, personal computer 22, personal computer 24, a smartphone (not shown), a personal digital assistant (not shown), a laptop computer (not shown), a tablet computer (not shown), a server computer (not shown) and a dedicated network device (not shown). Client electronic devices 22, 24 may each execute an operating system, examples of which may include but are not limited to Microsoft Windows™, Android™, iOS™, Linux™, or a custom operating system.

### Transfer Process

Assume for the following example that first entity 26 would like to transfer first asset 28 that are owned by first entity 26 to second entity 30.

Examples of first entity 26 may include but are not limited to: a first individual, a first business entity, and a first government entity. And examples of second entity 30 may include but are not limited to: a second individual, a second business entity, and a second government entity. For example, a first individual may wish to make a loan to his brother (a second individual) by transferring first asset 28 to the second individual. Alternatively, a first business entity may wish to settle an outstanding invoice owed to a second business entity by transferring first asset 28 to the second business entity. Additionally, a first government agency (e.g., the National Bank of one country) may wish to make a loan payment to a second government agency (e.g., a National Bank of another country) by transferring first asset 28 to the second government agency.

Depending upon where first entity 26 is located with respect to the location of second entity 30, a currency conversion may be required. For example, first asset 28 may be first currency (e.g., US Dollars), where first asset 28 will need to be converted into a different type of asset (e.g., a second currency) so that it may be used by second entity 30.

While the following example is going to concern an asset transfer between two entities where that asset is currency, this is for illustrative purposes only and is not intended to be a limitation of this disclosure, as other configuration are possible and are considered to be within the scope of this disclosure. For example, transfer process 10 may also be utilized to transfer other types of assets that have a discernable value. For example, instead of asset 28 being a quantity of one currency, asset 28 may represent a quantity of stock shares, a quantity of precious metals, a quantity of commodities, a quantity of precious stones, or a quantity of raw materials.

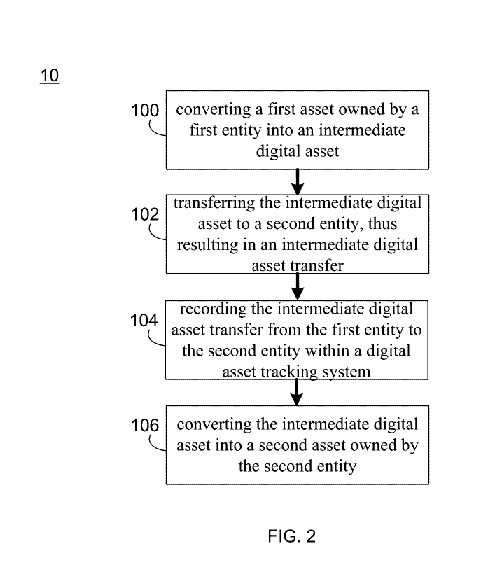

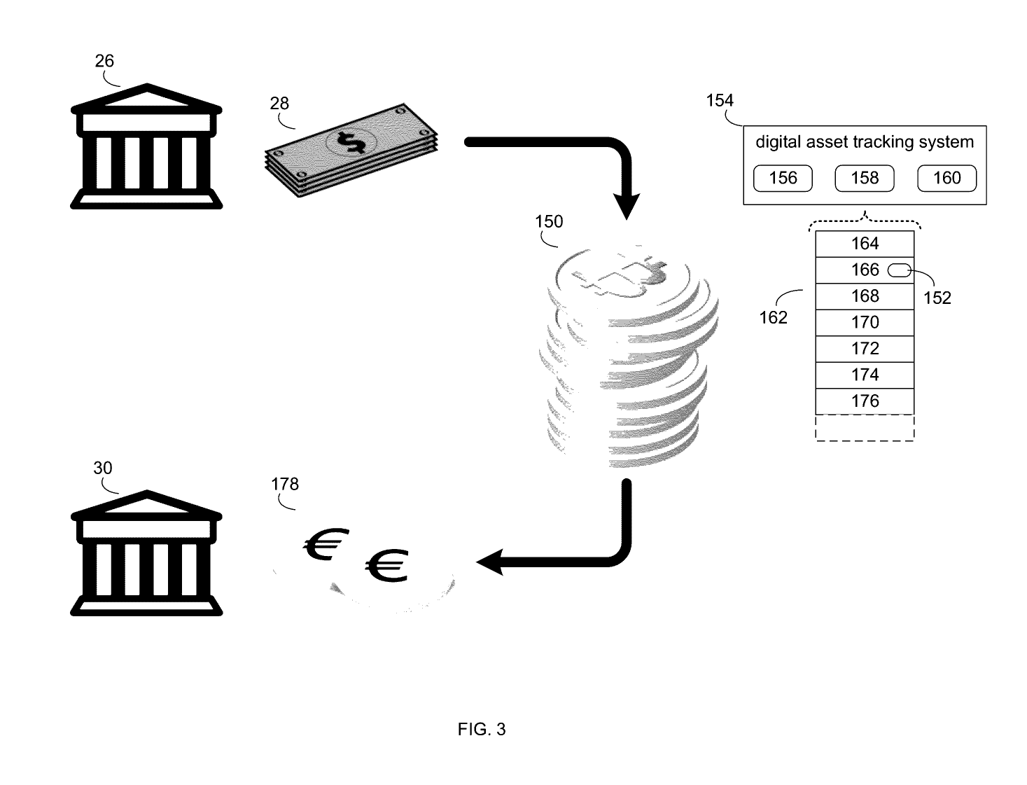

Referring also to FIGS. 2-3, assume that first entity 26 is a US corporation that wishes to transfer first asset 28 (which is in US dollars) to second entity 30, which is an Italian corporation. In order to effectuate the above-described asset transfer, transfer process 10 may convert 100 first asset 28 (which is owned by first entity 26) into an intermediate digital asset 150. Examples of intermediate digital asset 150 may include but are not limited to a cryptocurrency, a digital treasury bill and a digital contract. As is known in the art, a cryptocurrency (e.g., a Bitcoin) is a medium of exchange that utilizes cryptography to ensure that transactions are secure and to control the creation of new units of the currency. Further, a digital treasury bill is a secure digital version of the U.S. Treasury Bill, and a digital contract is a secure digital entity that has an assigned value.

Assume for the following example that intermediate digital asset 150 is the Bitcoin. Accordingly, transfer process 10 may convert 100 first asset 28 (which is in US Dollars) into intermediate digital asset 150 (which is in Bitcoins). Transfer process 10 may then transfer 102 intermediate digital asset 150 (which is in Bitcoins) to second entity 30 (which is an Italian corporation), thus resulting in intermediate digital asset transfer 152 (i.e., the transfer of intermediate digital asset 150 from first entity 26 to second entity 30). Transfer process 10 may record 104 intermediate digital asset transfer 152 from first entity 26 (which is a US corporation) to second entity 30 (which is an Italian corporation) within digital asset tracking system 154.

Digital asset tracking system 154 may be implemented in various ways. For example, digital asset tracking system 154 may include transfer tracking database system 156. Transfer tracking database system 156 may be configured to utilize a database to track transfers of intermediate digital asset 150 from (in this example) first entity 26 to second entity 30, wherein a database record may be created to document each transfer of intermediate digital asset 150. Additionally/alternatively, digital asset tracking system 154 may include transfer tracking ledger system 158, wherein (in a fashion similar to a database) an entry may be made in a digital ledger to document each transfer of intermediate digital asset 150.

Further, digital asset tracking system 154 may include block chaining system 160. As is known in the art, block chaining system 160 may function as a public ledger of all Bitcoin transactions that have ever occurred, wherein new transactions are stored within blocks, and when a block is completed, the completed block is appended to the end of the database (like adding a new link to a chain). Accordingly, as Bitcoin transactions continue to occur, new blocks are completed, which are append to blockchain 162 (which continues to grow in size). As blocks are completed, they are added in a linear, chronological order to blockchain 162.

For example, assume that at the time that intermediate digital asset transfer 152 was recorded 104, block 164 was already completed and added to blockchain 162. Accordingly, intermediate digital asset transfer 152 may be recorded within (in this example) block 166 of blockchain 162. Upon completion, block 166 may be appended to the end of blockchain 162 and onto block 164, wherein block 166 may reference block 164 so that the sequencing of the blocks within blockchain 162 may be memorialized. For example, block 168 may be appended to and may reference block 166; block 170 may be appended to and may reference block 168; block 172 may be appended to and may reference block 170; block 174 may be appended to and may reference block 172; and block 176 may be appended to and may reference block 174.

Each node (e.g., computing device 12, personal computer 22 and personal computer 24) configured to interact with block chaining system 160 may obtain a copy of blockchain 162 (e.g., the sum of blocks 164, 166, 168, 170, 172, 174, 176). As discussed above, blockchain 162 has complete information (e.g., transferring entity, receiving entity, transfer quantity, etc.) concerning all transfers that have occurred using block chaining system 160.

As discussed above, first entity 26 is a US corporation (that uses US dollars) and second entity 30 is an Italian corporation. As the currency of Italy is the Euro, transfer process 10 may convert 106 intermediate digital asset 150 (which is, in this example, in Bitcoins) into second asset 178 (e.g., in Euros), which is now owned by second entity 30. Accordingly and through the use of transfer process 10, first entity 26 was able to transfer first asset 28 (which was in US dollars) to second entity 30, resulting in second entity 30 receiving second asset 178 via intermediate digital asset transfer 152 of intermediate digital asset 150.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
converting a first asset owned by a first entity into an intermediate digital asset;
transferring the intermediate digital asset to a second entity, thus resulting in an intermediate digital asset transfer;
recording the intermediate digital asset transfer from the first entity to the second entity within a digital asset tracking system; and
converting the intermediate digital asset into a second asset owned by the second entity.

2. The computer-implemented method of claim 1 wherein:
the first asset is a first currency; and
the second asset is a second currency.

3. The computer-implemented method of claim 1 wherein the intermediate digital asset includes one or more of:
a cryptocurrency;
a digital treasury bill; and
a digital contract.

4. The computer-implemented method of claim 1 wherein the digital asset tracking system includes a transfer tracking database system.

5. The computer-implemented method of claim 1 wherein the digital asset tracking system includes a block chaining system.

6. The computer-implemented method of claim 1 wherein the digital asset tracking system includes a transfer tracking ledger system.

7. The computer-implemented method of claim 1 wherein:
the first entity includes one or more of: a first individual, a first business entity, and a first government entity; and
the second entity includes one or more of: a second individual, a second business entity, and a second government entity.

8. A computer program product residing on a computer readable medium having a plurality of instructions stored thereon which, when executed by a processor, cause the processor to perform operations comprising:
converting a first asset owned by a first entity into an intermediate digital asset;
transferring the intermediate digital asset to a second entity, thus resulting in an intermediate digital asset transfer;
recording the intermediate digital asset transfer from the first entity to the second entity within a digital asset tracking system; and
converting the intermediate digital asset into a second asset owned by the second entity.

9. The computer program product of claim 8 wherein:
the first asset is a first currency; and
the second asset is a second currency.

10. The computer program product of claim 8 wherein the intermediate digital asset includes one or more of:
a cryptocurrency;
a digital treasury bill; and
a digital contract.

11. The computer program product of claim 8 wherein the digital asset tracking system includes a transfer tracking database system.

12. The computer program product of claim 8 wherein the digital asset tracking system includes a block chaining system.

13. The computer program product of claim 8 wherein the digital asset tracking system includes a transfer tracking ledger system.

14. The computer program product of claim 8 wherein:
the first entity includes one or more of: a first individual, a first business entity, and a first government entity; and
the second entity includes one or more of: a second individual, a second business entity, and a second government entity.

15. A computing system including a processor and memory configured to perform operations comprising:
converting a first asset owned by a first entity into an intermediate digital asset;
transferring the intermediate digital asset to a second entity, thus resulting in an intermediate digital asset transfer;
recording the intermediate digital asset transfer from the first entity to the second entity within a digital asset tracking system; and
converting the intermediate digital asset into a second asset owned by the second entity.

16. The computing system of claim 15 wherein:
the first asset is a first currency; and
the second asset is a second currency.

17. The computing system of claim 15 wherein the intermediate digital asset includes one or more of:
a cryptocurrency;
a digital treasury bill; and
a digital contract.

18. The computing system of claim 15 wherein the digital asset tracking system includes a transfer tracking database system.

19. The computing system of claim 15 wherein the digital asset tracking system includes a block chaining system.

20. The computing system of claim 15 wherein the digital asset tracking system includes a transfer tracking ledger system.

21. The computing system of claim 15 wherein:
the first entity includes one or more of: a first individual, a first business entity, and a first government entity; and
the second entity includes one or more of: a second individual, a second business entity, and a second government entity.
